(19) United States
(12) Patent Application Publication
(10) Pub. No.: US 2025/0317466 A1
(43) Pub. Date: Oct. 9, 2025

(54) System and Method for Improving Cybersecurity of a Network

(71) Applicant: The Government of the United States of America, as represented by the Secretary of Homeland Security, Washington, DC (US)

(72) Inventor: Mark A. Fry, Marco Island, FL (US)

(73) Assignee: The Government of the United States of America, as represented by the Secretary of Homeland Security, Washington, DC (US)

(21) Appl. No.: 19/097,469

(22) Filed: Apr. 1, 2025

Related U.S. Application Data
(60) Provisional application No. 63/573,686, filed on Apr. 3, 2024.

(51) Int. Cl. H04L 9/40; H04L 41/16

(52) U.S. Cl. CPC H04L 63/1433; H04L 41/16

(57) ABSTRACT

A system and method for mitigating cyber-attacks against a target network comprising interconnected note that is implemented by Open Systems Interconnection (OSI) layers monitors the target network for detecting vulnerabilities across one or more OIS layers. a virtual network comprising a virtualized representation of the target network where the virtual network includes one or more virtual nodes that are annotated with identified vulnerabilities of one or more corresponding nods of the target network. A reference database can be configured to store records of known cyber-attacks and their corresponding mitigations where cyber-attacks on the virtual network are simulated based on records of known cyber-attacks and successful cyber-attacks. An AI engine can be configured to generate one or more mitigation actions based on simulation of the cyber-attacks before implementing the one or more mitigation actions to the target network.

### CROSS-REFERENCES

This application claims priority to U.S. Provisional Application No. 63/573,686, filed on Apr. 3, 2024.

### STATEMENT OF GOVERNMENT INTEREST

The present invention was made by United States Department of Homeland Security employees in performing their official duties.

### FIELD

The invention generally relates to systems and methods for improving network security.

### BACKGROUND

Cyber-attacks have matured from unfocused, unsophisticated criminal activities to long-term campaigns against targeted entities using advanced attack tools. For example, one type of cyber activity known as Advanced Persistent Threat (APT) poses a significant danger to every business, government, or military, having data that must be protected from public disclosure. The costs of resolving cyber-attacks are also financially burdening to organizations. However, expenses related to attack cleanup pale compared to the long-term costs associated with the disclosure of valuable intellectual property, confidential data, trade secrets, business plans, and other data targeted by cyber attackers focused on extracting intelligence from their targets. Loss of data managed by regulatory stipulations, such as consumer financials, the Health Insurance Portability and Accountability Act (HIPAA), Sarbanes Oxley, or military data, could result in significant fines and law enforcement action. The income loss and costs of re-establishing customer confidence once a data breach is publicly reported can be devastating.

There are known techniques for detecting cyber-attacks using various devices and methods. Network monitoring and attack discovery products and tools, including open-source tools, have provided secure networks. Cyber-security defense products, such as Intrusion Detection Systems (IDI), provide “fact of” alerts based on known attack-like behaviors or malware signatures. Network-monitoring products and services can collect network traffic to assess the vulnerabilities of target networks to cyber-attacks.

A security information and event management (SIEM) solution is an essential component of effective cybersecurity. These solutions collect, aggregate, and analyze large volumes of data from organization-wide applications, devices, servers, and users in real-time. By consolidating this vast array of data into a unified platform, SIEM solutions provide a comprehensive view of an organization's security posture, empowering security operation centers (SOC) to detect, investigate, and respond to security incidents swiftly and effectively. SIEM solutions can help organizations of all sizes:
Gain visibility into their security posture by centralizing and analyzing data from disparate sources,
Detect and identify potential security breaches and threats in real-time, minimizing the risk of compromise,
Investigate and triage security incidents efficiently, reducing the time and resources that may be required for resolution.
Comply with regulatory and industry-specific security standards and frameworks,

It is known to analyze network traffic in real-time, i.e., “online.” Snort (www.snort.org) is a free and open-source network intrusion prevention system (NIPS) and network intrusion detection system (NIDS) capable of performing real-time traffic analysis, and packet logging on Internet Protocol (IP) networks using tools that perform protocol analysis, content searching, and matching to detect attacks to operating systems, fingerprinting attempts, a common gateway interface, buffer overflows, server message block probes, and stealth port scans. Snort can analyze application-level vulnerabilities, including binary code in Hypertext Transfer Protocol (HTTP) headers, HTTP/HTTPS tunneling, URL directory traversal, cross-site scripting, and SQL injection will also be analyzed.

There have also existed cyber-security-related patents and publications, including:
U.S. Pat. No. 11,245,713 (incorporated by reference in its entirety), which discloses techniques for providing an orchestrated response to a cybersecurity threat;
U.S. Pat. No. 11,611,578 (incorporated by reference in its entirety), which discloses systems and methods for assessing the cybersecurity risk of a computer network, includes the use of a risk model application that is configured to determine an initial cyber risk score value based upon an underwriting process;

U.S. Patent Application Publication No. 2022/0210200 (incorporated by reference in its entirety), which discloses a system and method for automated cybersecurity defensive strategy analysis that predicts the evolution of new cybersecurity attack strategies and makes recommendations for cybersecurity improvements to networked systems based on a cost/benefit analysis;
“Innovation Insight for Attack Surface Management” by Mitchell Schneider, John Watts, and Pete Shoard, published on Mar. 24, 2022, describes how information security teams are responsible for identifying and managing an attack surface across internal and external digital assets. Security and risk management leaders aware of their attack surface can improve their risk posture by prioritizing security hygiene and increasing its visibility and
“Internet Crime Report 2021” by the Federal Bureau of Investigation discusses statistics and findings by the FBI on cyberattacks and cybersecurity methods.

Also known are methods that use machine learning (ML) in cybersecurity applications, including:
“A survey of data mining and machine learning methods for cyber security intrusion detection” by Buczak et al., published in 2015;
“Intrusion Detection System in Software-Defined Networks Using Machine Learning and Deep Learning Techniques—A Comprehensive Survey” by Ahmed et al. published Oct. 31, 2023; and
“Applying big data based deep learning system to intrusion detection” by Zhong et al., published in 2020.

However, none of the known methods use data from network attacks and intrusions to train and deploy AI/ML algorithms to help reduce or eliminate network vulnerabilities to cyber-attacks.|

### SUMMARY

Briefly, according to the present invention, a system and method for mitigating cyber-attacks against a target network comprising interconnected note that is implemented byOpen Systems Interconnection (OSI) layers monitors the target network for detecting vulnerabilities across one or more OIS layers. a virtual network comprising a virtualized representation of the target network where the virtual network includes one or more virtual nodes that are annotated with identified vulnerabilities of one or more corresponding nods of the target network. A reference database can be configured to store records of known cyber-attacks and their corresponding mitigations where cyber-attacks on the virtual network are simulated based on records of known cyber-attacks and successful cyber-attacks. An AI engine can be configured to generate one or more mitigation actions based on simulation of the cyber-attacks before implementing the one or more mitigation actions to the target network.

According to some of the more detailed features of the present specification, the one or more mitigation actions comprise at least one of: 1) automatic application of security patches, 2) firewall rule modification, 3) role-based access control (RBAC) enforcement, 4) session termination 5) altering user access rights, 6) sub-isolating a vulnerable node; 7) disabling a compromised account and 8) instituting a lockdown protocol. The simulation of the cyber-attacks on the target network are based on at least one of data associated with cyber-attacks against one or more networks other than the target network and data associated with past cyber-attacks against the target network.

According to other more detailed features of the present specification, the AI engine can comprises a deep neural network trained to classify attack types by an OSI layer where training data for the AI engine can includes at least one of structured data and unstructured data associated with cyber-attacks. A cyber-security threat alert can be generated categorized by one or more severity levels and records of successful cyber-attacks includes at least one of a timestamp, a source, and an attack vector.

According to still other more detailed features of the present specification triage can be used to assign risk scores to the vulnerabilities, where the triage can use a weighted scoring formula to assign the risk scores to the vulnerabilities based on at least one of probability of breach, business impact, exploit availability, or regulatory risk. The system and method of the present specification can simulate what-if scenarios based on the one or more mitigation actions.

### BRIEF DESCRIPTION OF DRAWINGS

FIG. 1 shows block diagram of the cybersecurity system protecting a target network.

FIG. 2 shows a flow chart for implementing the present specification.

FIG. 3 shows a block diagram of the target network.

FIG. 4 shows a block diagram of the target network inspector.

FIG. 5 depicts functional blocks used for detecting layered vulnerabilities.

FIG. 6 shows a flow chart of functional steps that analyze network vulnerabilities.

FIG. 7 shows steps for the implementation of the virtual model of the target network with annotated layer descriptions.

FIG. 8 shows flow chart used generating a model of the target network.

FIG. 9 shows a conceptual illustration of virtual network components and their physical network equivalents.

FIG. 10 shows a block diagram of the architecture of an integrated virtual cyber defense system.

FIG. 12 shows functional blocks for mapping attacks and running “what-if” scenarios.

FIG. 11 shows functional block diagram that implements AI/ML for threat pattern detection.

### DETAILED DESCRIPTIONS OF DRAWINGS

As described herein, the present specification relates to a system that can protect a target network against cyber-attacks. The target network can be a wide area network (WAN), a local area network (LAN), a wired or wireless private or public network, an intranet, or any combination thereof. The target network can comprise wired or wireless interconnected physical or logical nodes, each having one or more hardware or software implemented processing units, such as virtual machines (VMs), central processing units (CPUs), microprocessors, embedded controllers, digital signal processors (DSPs), a client, a server, a router, a hub, an access point. Such physical or virtual processing units can have processing power for executing codes, programs, and/or applications that support various networking protocols, enabling interconnected nodes to communicate with each other according to an implemented network topology. The topology describes the layout of elements in the target network and their connections. Network topology includes star topology, bus topology, ring topology, dual-ring topology, tree topology, and mesh topology. In the case of physical network topology, the connections between network nodes refer to physical connections. In the case of virtual network topology, the connections between the nodes refer to logical data flows. The target network can have one underlying physical topology describing physical connections and a different virtual topology describing how data flows between nodes logically.

The target network can be implemented based on layers defined by the Open Systems Interconnection (OSI) model. Such OSI layers include 1) a physical layer for connection between nodes (e.g., ethernet cables, fiber optic cables, wireless signals (e.g., Wi-Fi), 2) a data link layer for node-to-node delivery of the message (e.g., Network Interface Cards (NICs), network switches and media access control (MAC) addressing), 3) a network layer for routing of data (e.g., routers), 4) a transport layer for end-to-end delivery of complete messages (e.g., operating systems Transmission Control Protocol (TCP) and User Datagram Protocol (UDP) stacks), 5) a session layer for the establishment of connections, management of connections and terminations of sessions between two nodes (e.g., operating system session managers) 6) a presentation layer for data translation, e.g., encryption/decryption modules such as Transport Layer Security (TLS) and Secure Sockets Layer (SSL) designed to provide secure communication over a computer network and 7) an application layer for displaying received information to users (e.g., web browsers and email clients).

### Cyber Security System

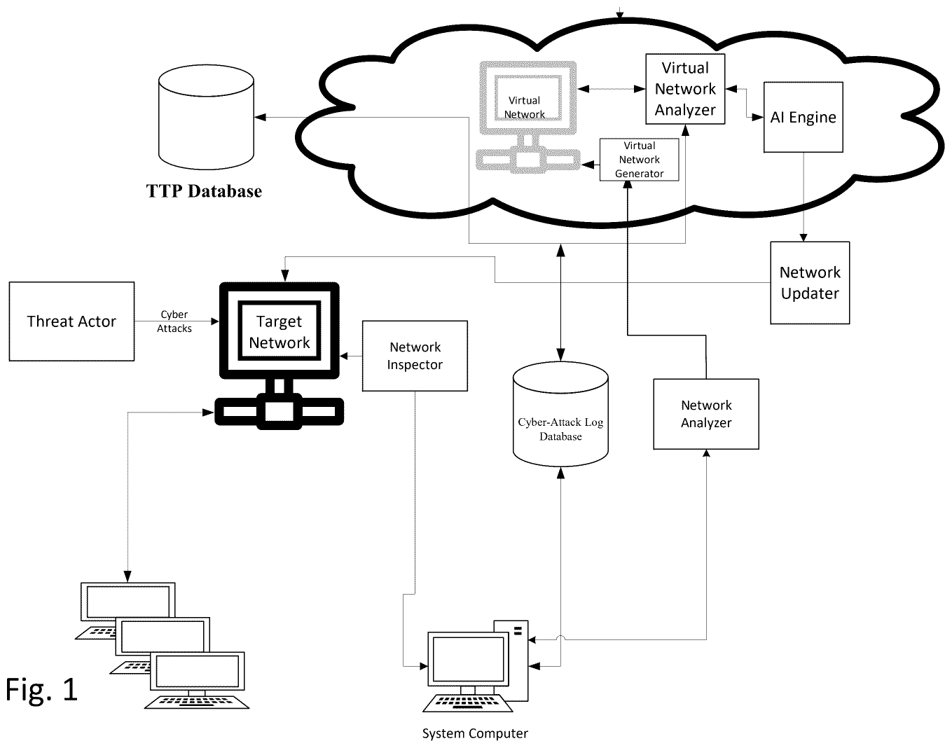

FIG. 1 shows block diagram of the cybersecurity system protecting a target network, which can be subject to cyber-attacks threat actors. The system includes a computer, such as a server, that accesses a database, which stores logged cyber-attacks on the target network (the cyber-attack log database). More specifically, the database stores records of successful cyber-attacks and unsuccessful cyber-attacks. As a result, the cyber-attack log database maintains the history of cyber-attacks on the target network. A cybersecurity attack (cyber-attack) on the target network is any attempt to gain illegal access to the target network to cause damage or harm. For example, a cyber-attack can be any illicit attempt (successful or unsuccessful) to compromise the target network's or one or more of its sub-nets' ability to protect data or users, recover data, access data, keep data secure, identify threats, respond to threats, etc. More specifically, a cyber-attack may be a deliberate attempt by threat actors to exploit vulnerabilities in the target networks to disrupt, damage, steal, or gain unauthorized access to data or services. Cyber-attacks include malware, phishing, ransomware, SQL infusion, zero-day exploits, denial-of-service (DOS) attacks, and man-in-the-middle (MITM) attacks. These attacks can be carried out for financial gain, espionage, political motives, or personal revenge, posing significant risks to individuals, organizations, and governments.

### TTP Database

The present specification uses a reference database containing information about one or more tactics, techniques, and procedures (TTPs) associated with historical cyber-attacks. One such TTP database is the MITRE ATT&CK® database (attack.mitr.org), a globally accessible knowledge base of adversary tactics and techniques collected based on real-world observations. Other databases that contain TTP records include the databases maintained by the Center for International and Security Studies at Maryland (CISSM) (https://cissm.umd.edu/cyber-events database) and JAM Cyber (https://jamcyber.com/discover/cyber-attacks/)

The MITRE ATT&CK® database has been used as a foundation for developing specific threat models and methodologies in the private sector, government, and the cybersecurity product and service community. MITRE ATT&CK® database can be found at URL address https://attack.mitre.org/resources/attack-data-and-tools. The MITRE ATT&CK® database uses a framework that categorizes cyber-attacks into tactics, techniques, and procedures.

Tactics represent the “why” of an ATT&CK technique or sub-technique. The adversary's tactical goal is the reason for performing an action. For example, an adversary may want to achieve credential access. Table 1 below lists some cyber-attack types against the target network, the corresponding attack tactic, type, description, and an example.

TABLE 1

| MITRE Tactic | Attack Type | Description | Example |
|---|---|---|---|
| Initial Access | Phishing | Attackers send malicious emails with links or | Spear-phishing targeting |
| | | attachments. | employees. |
| Execution | Remote Code Execution | Exploiting software vulnerabilities to execute | Log4Shell exploit. |
| | (RCE) | malicious commands. | |
| Persistence | Backdoor Installation | Attackers maintain access via malware or | Hidden scheduled tasks or |
| | | misconfigurations. | registry changes. |
| Privilege Escalation | Exploiting Kernel | Gaining higher privileges through OS | CVE-2021-3156 (Sudo Buffer |
| | Vulnerabilities | weaknesses. | Overflow). |
| Defense Evasion | Disabling Security Tools | Tampering with AV or SIEM to avoid detection. | Modifying Windows Defender |
| | | | settings. |
| Credential Access | Pass-the-Hash Attack | Stealing hashed credentials to authenticate. | Mimikatz usage. |
| Discovery | Network Scanning | Identifying live hosts and open ports. | Nmap scans for SSH servers. |

Techniques represent ‘how’ an adversary achieves a tactical goal by acting. For example, an adversary may dump credentials to achieve credential access. Table 2 below shows an example table of MITRE ATT&CK techniques, showing their core attributes and how they map to OSI layers:

TABLE 2

| Technique | | | | | |
|---|---|---|---|---|---|
| ID | Technique Name | Tactic | Description | OSI Layer | Example Indicator |
| T1190 | Exploit Public-Facing | Initial Access | Exploits vulnerabilities in | Layer 7 | Unexpected HTTP POSTs to |
| | Application | | internet-facing apps to gain | (Application) | unknown endpoints |
| | | | unauthorized entry | | |
| T1059 | Command and Scripting | Execution | Executes arbitrary scripts or | Layer 7 | New PowerShell or bash |
| | Interpreter | | commands on a target system | (Application) | processes launched |
| | | | | | unexpectedly |
| T1078 | Valid Accounts | Persistence/ | Uses legitimate credentials to | Layer 7 | Login events from unusual IP |
| | | Initial Access | maintain access or gain entry | (Application) | addresses or times |
| T1557 | Man-in-the-Middle | Credential | Intercepts or alters network traffic | Layer 2 (Data | ARP table anomalies, |
| | | Access | to steal credentials or data | Link) | unexpected SSL certificates |
| T1499 | Endpoint Denial of | Impact | Overloads a system or application | Layer 7 | Spike in malformed requests |
| | Service | | with traffic/resource exhaustion | (Application) | and high CPU/memory usage |
| | | | | | on target |

Mitigations represent security concepts and classes of technologies that can be used to prevent a technique or sub-technique from being successfully executed. Table 3 below shows an example table of MITRE ATT&CK mitigations, showing how each map to specific techniques, OSI layers, and implementation examples:

TABLE 3

| | | | Mitigated | | |
|---|---|---|---|---|---|
| Mitigation ID | Mitigation Name | Description | Techniques | OSI Layer | Implementation Example |
| M1010 | Network | Divide network into | T1075 (Pass the | Layer 3 | Configure VLANs, ACLs, and |
| | Segmentation | zones to restrict | Hash), T1021 | (Network) | internal firewalls |
| | | lateral movement | (Remote Exec) | | |
| M1020 | Multi-Factor | Require ≥2 | T1110 (Brute Force), | Layer 7 | Enforce hardware tokens or |
| | Authentication | authentication factors | T1078 (Valid | (Application/ | authenticator apps |
| | | | Accounts) | User) | |
| M1030 | Input Validation | Validate and sanitize | T1059 (Command | Layer 7 | Use parameterized queries and web |
| | | all user inputs | Execution), T1190 | (Application) | application firewall |
| | | | (Injection) | | |
| M1040 | Application | Remove/disable | T1203 | Layer 7 | Disable unused modules, enforce |
| | Hardening | unnecessary features | (Exploitation), | (Application) | least privilege |
| | | | T1499 (DoS) | | |
| M1050 | Patch Management | Apply security | T1190 (Injection), | Layer 7 | Automate OS/software patch |
| | | updates promptly | T1210 (Exploitation | (Application) | deployment & reporting |
| | | | for Defense Evasion) | | |

### Cyber-Attack Log Database

The records stored in the cyber-attack log database may contain information on cyber-attacks by adversaries seeking to infiltrate or compromise the target network's security. The database can store details of detected attacks, which can be used for forensic analysis, threat intelligence, and automated mitigation. More specifically, the cyber-attack log database storing historical records of successful and unsuccessful cyber-attacks including attack type, source, impact, and exploited vulnerabilities. The cyber-attack log database can include metadata fields comprising timestamp, OSI layer targeted, attack vector, mitigation actions taken, and residual impact. Table 4 below shows structured fields that reflect details about various attacks according to a table schema.

TABLE 4

| Attack_ID | Date & Time | Attack_Type | Source_IP | Target_IP | Impact_Level | Attack_Vector |
|---|---|---|---|---|---|---|
| 1001 | 2025 Mar. 14 | Phishing | 192.168.1.10 | 10.0.0.5 | High | Email |
| | 10:35:00 | | | | | Attachment |
| 1002 | 2025 Mar. 13 | Ransom | 203.0.113.45 | 10.0.0.8 | Critical | Malicious File |
| | 22:12:00 | ware | | | | Download |
| 1003 | 2025 Mar. 12 | DDoS | 198.51.100.12 | 10.0.0.1 | Severe | Botnet Traffic |
| | 16:45:00 | | | | | |
| 1004 | 2025 Mar. 11 | SQL | 185.199.109.20 | 10.0.0.100 | Medium | Web Form Input |
| | 08:25:00 | Injection | | | | |
| 1005 | 2025 Mar. 10 | Man-in- | 192.0.2.15 | 10.0.0.12 | High | ARP Spoofing |
| | 14:50:00 | the- | | | | |
| | | Middle | | | | |

Where:
Attack_ID can be a unique identifier for each cyber attack record,
Date & Time can be a timestamp when each attack occurred,
Attack_Type can be a category of cyber attack (e.g., Phishing, Ransomware, DDOS),
Source_IP can be the IP address from where the attack originated,
Target_IP can be the IP address of the system that was targeted,
Impact_Level can be the severity of the attack (e.g., Low, Medium, High, Critical),
Attack_Vector can be the method used to execute the attack,

The target network can interface with a target network inspector configured to store records of successful and unsuccessful cyber-attacks, which can be used to determine the target network's vulnerabilities. Table 6 below shows examples of vulnerabilities at OSI layers and associated attack techniques and mitigation strategies.

TABLE 5

| OSI Layer | Vulnerabilities | MITRE ATT&CK Techniques | Mitigation Strategies |
|---|---|---|---|
| Layer 7: | Weak authentication, SQL Injection, | T1190 - Exploit Public-Facing | WAF, Input validation, Multi- |
| Application Layer | Cross-Site Scripting (XSS) | Application, T1189 - Drive-by | Factor Authentication (MFA) |
| | | Compromise | |
| Layer 6: | Weak encryption, Format String | T1600 - Data Manipulation | TLS 1.3, Strong encryption policies |
| Presentation Layer | vulnerabilities | | |
| Layer 5: Session | Session hijacking, Cookie theft | T1071 - Application Layer Protocol | Secure session tokens, HTTPOnly |
| Layer | | | & Secure cookies |
| Layer 4: Transport | Man-in-the-Middle (MITM), DoS | T1040 - Network Sniffing, T1498 - | TLS encryption, Rate-limiting, |
| Layer | attacks | Network DoS | DDoS protection |
| Layer 3: Network | BGP hijacking, IP spoofing, | T1090 - Proxy, T1133 - External Remote | Network segmentation, VPN, IP |
| Layer | Unauthorized access | Services | whitelisting |
| Layer 2: Data Link | MAC spoofing, ARP poisoning, | T1557 - Adversary-in-the-Middle (AiTM) | ARP inspection, MAC filtering, |
| Layer | VLAN hopping | | VLAN isolation |
| Layer 1: Physical | Rogue devices, Cable tapping, | T1200 - Hardware Additions | Network access control (NAC), |
| Layer | Hardware Trojans | | Fiber optic security |

The target network inspector can interface with a target network analyzer configured to generate a virtual network using a virtual network generator implemented in the cloud. The virtual network is modeled by the virtual network generator to emulate target network vulnerabilities detected by the target network inspector. The network analyzer can implement the OSI layers of the target network using logical constructs that exist in tangible, non-transitory computer memory. The virtual network generator can be configured to generate the virtual network, for example, in the cloud as a target network model, where the implemented virtual network may comprise one or more or all of virtualized components of the target network layers that emulate its node-level, sub-net level or network level vulnerabilities. A virtual network analyzer utilizes records of target network vulnerabilities to improve the target network's security using the TTP database. For example, the virtual network analyzer may run vulnerability simulations against some or all of the nodes of the virtual network to determine whether the security of the virtual network can be attacked using mitigation action mechanisms described in the TTP records. An AI engine can be configured to generate one or more mitigation actions based on simulation of the cyber-attacks. The AI engine can comprise a deep neural network trained to classify attack types by OSI layer based on packet metadata, protocol behavior, and attack signatures. The virtual network analyzer can interface with a network updater, which is configured to deploy changes in the target network based on the virtual network analysis to minimize or remove the vulnerability in the target network.

System architecture diagrams of FIG. 1 can implement interconnectivity between the target network, the cyber-attack log database, the virtual network environment, and external threat intelligence sources using APIs, secured message queues, or event triggers within SIEM or Security Orchestration, Automation, and Response (SOAR) workflows.

### Cyber Security System Implementation

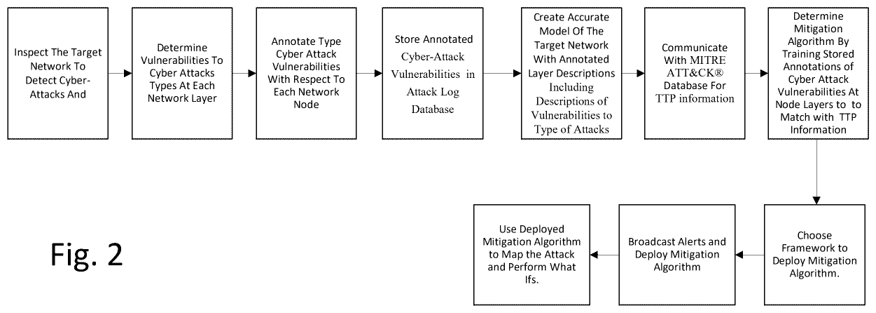

FIG. 2 shows a flow chart for implementing the present specification by 1) inspecting the target network to detect cyber-attacks, 2) determining vulnerabilities to cyber-attacks types at one or more network layers, 2) annotating types of cyber-attack vulnerabilities with respect to one or more network nodes, 3) storing annotated cyber-attack vulnerabilities in the attack log database, 4) creating an accurate model of the target network and its vulnerabilities with annotated layer descriptions 4) communicating with MITRE ATT&CK® database for TTP information, including descriptions of threats and type of attacks, 4) determining mitigation algorithm by training stored annotations of the cyber-attack vulnerabilities at node layers to match with TTP information, 5) choosing a framework to deploy the mitigation algorithm, 6) broadcasting alerts and implement defenses, and 7) using the deployed algorithms to map the attack and perform what ifs.

### The Target Network

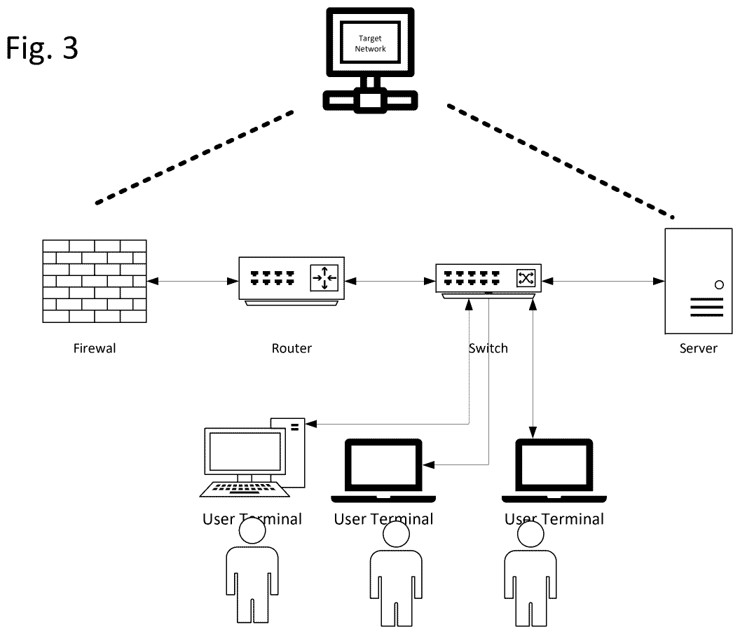

FIG. 3 shows a block diagram of the target network. The target network is protected by a firewall, which acts as a security barrier, filtering incoming and outgoing traffic to protect network resources. A router connected to the firewall transports data packets between the network and external networks, such as the Internet or other private networks or subnets, using the TCP/IP protocol. A switch connects multiple user terminals to a server, enabling internal communication. The server hosts applications, files, or authentication services and responds to requests from user terminals, which can be workstations or devices accessing resources from the server.

### The Network Inspector

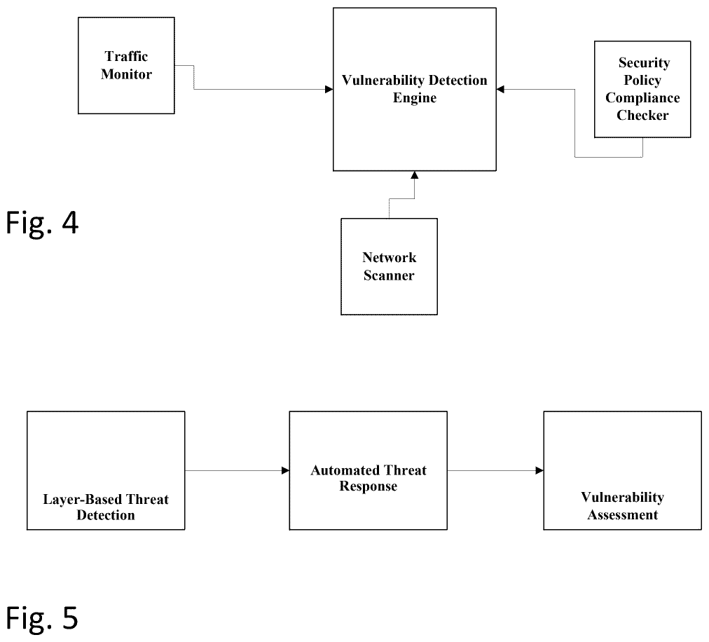

FIG. 4 shows a block diagram of the target network inspector, which can scan the target network to identify devices and running services, analyze traffic and services, and look for vulnerabilities in one or more OIS layers. A vulnerability can be a weakness in a cyber security attack. A network vulnerability may be a weakness, flaw, or misconfiguration in a network's hardware, software, or security protocols that a threat actor could exploit to gain unauthorized access, disrupt operations, steal data, or compromise system integrity. Such vulnerabilities include but are not limited to outdated software, improper configurations, unpatched software, and firmware or security flaws, weak authentication and password, micro-configured network devices, unsecured wireless networks, open ports and services, phishing, and social engineering vulnerabilities, denial of service vulnerabilities, and lack of network segmentation or insecure network architecture.

The target network inspector includes a network scanner, a traffic monitor, a security policy compliance checker, and a vulnerability detection engine. The network scanner, which can be implemented by such tools as Nmap Angry IP Scanner, may identify active devices, hosts, and network topology, for example, using such components as:
IP address scanner, which can detect connected devices and their IP addresses,
Port scanner, which can identify open ports on network devices and
Service fingerprinting determines running services and protocols (e.g., SSH, FTP, HTTP).

The traffic monitor, which can be implemented by such tools as Wireshark Zeek (Bro IDS), may analyze live network traffic for suspicious patterns, for example, using such components as:
Intrusion Detection System (IDS), which identifies potential cyber threats.
Protocol analyzer, which inspects HTTP, Domain Name System (DNS), Secure Shell Protocol (SSH), and other traffic for anomalies and
The bandwidth monitor detects unusual spikes in traffic, indicating a possible attack.

The security policy compliance checker, which can be implemented by such tools as Qualys Policy Compliance Tripwire, can ensure the network follows security best practices and regulations, for example, using such components as:
Firewall rule validator, which reviews firewall configurations for misconfigurations.
Access control evaluator, which checks user permissions and role-based access and
Regulatory compliance scanner ensures compliance with applicable standards, such as International Organization for Standardization (ISO), National Institute of Standards and Technology (NIST), General Data Protection Regulation (GDPR), and Health Insurance Portability and Accountability Act (HIPAA).

### The Vulnerability Detection Engine

FIG. 5 depicts functional blocks used for detecting layered vulnerabilities. The vulnerability detection engine (VDE) identifies OSI layer vulnerabilities at one or more OSI layers. In a layer-based threat detection step, live traffic can be monitored at one or more OSI layers, or a threat feed integration module can be used to pull real-time threat data from external sources. Based on the detected threats, automated layer-based responses can be initiated. For example, if a layer seven attack, such as SQL Injection, is detected, the VDE can dynamically deploy Web Application Firewall (WAF) rules. If a layer two attack, such as Address Resolution Protocol (ARP) spoofing, is attempted, the VDE can enforce dynamic ARP inspection. If a layer 4 Man-in-the-Middle attack (MITM) is detected, the VDE can trigger encryption enforcement. In a vulnerability assessment step, the effectiveness of the response is analyzed to assess layer-based vulnerabilities by evaluating weaknesses at one or more OSI layer using AI and signature-based detection. Moreover, a Common Vulnerability Exposure (CVE) database integration module can match detected services with known vulnerabilities. A patch and update scanner module can check for outdated firmware and software. A misconfiguration analyzer module can detect weak security settings (e.g., default passwords and open access points). A threat intelligence analyzer module can detect advanced persistent threats (APTs) and zero-day vulnerabilities. A sandboxing system can test suspicious files in an isolated environment. Tools like OpenVAS, Nessus, IBM QRadar, and Cisco SecureX can implement the vulnerability detection engine to detect weaknesses in network devices, configurations, and services. Table 6 below lists shared layer-based vulnerabilities and corresponding detection techniques.

TABLE 6

| OSI Layer | Common Vulnerabilities | Detection Techniques |
|---|---|---|
| Layer 7: Application | SQL Injection, XSS, Buffer Overflow | Web App Scanners (Burp Suite, OWASP ZAP) |
| Layer 6: Presentation | Weak encryption, TLS downgrade attacks | SSL/TLS Scanners (Qualys SSL Labs, OpenSSL) |
| Layer 5: Session | Session hijacking, replay attacks | Behavioral Analysis (User Session Monitoring) |
| Layer 4: Transport | TCP SYN flood, UDP amplification | Intrusion Detection (Snort, Suricata) |
| Layer 3: Network | IP spoofing, BGP hijacking | Routing Anomaly Detection (BGP Monitoring) |
| Layer 2: Data Link | ARP spoofing, MAC flooding | Packet Inspection (Wireshark, ARPwatch) |
| Layer 1: Physical | Rogue devices, cable tapping | Network Access Control (802.1X, Port Security) |

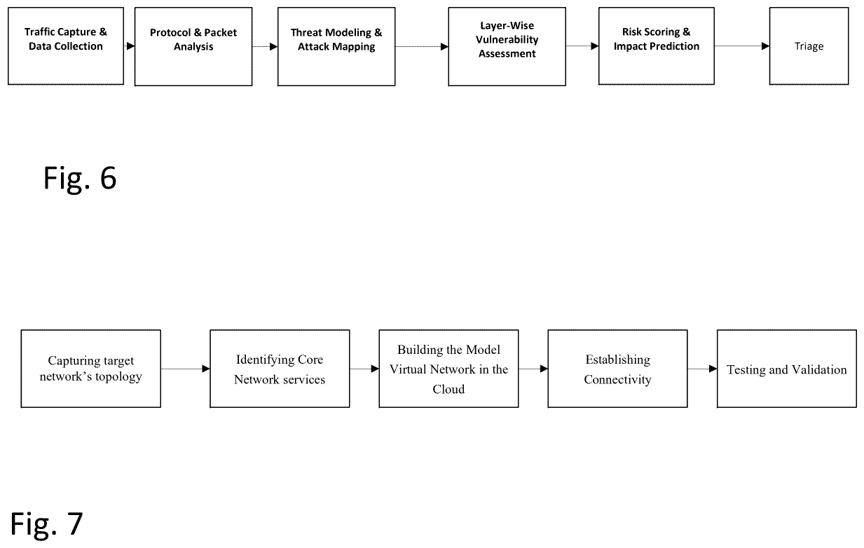

FIG. 6 shows a flow chart of functional steps that analyze network vulnerabilities at one or more OSI layers by identifying attack surfaces and threat vectors of potential exploits. A traffic capture & data collection step gathers real-time and historical network traffic and security events, including collecting network packets, system logs, and security alerts using intrusion detection systems (IDS) and Security Information and Event Management (SIEM) platforms, for example, by capturing malformed Internet Control Message Protocol (ICMP) packets from a suspected DDOS attack. A protocol and packet analysis step examines communication protocols and packet structures for vulnerabilities by inspecting network headers, payloads, and encryption methods to identify protocol misconfigurations and insecure traffic, for example, by detecting cleartext passwords in HTTP requests, flagging an OIS layer seven vulnerability. Threat modeling and attack mapping steps match network activity to known cyber threats and vulnerabilities in the cyber-attack log stored in the database. MITRE ATT&CK database can be used to classify attack techniques using one or more OSI layers. A risk scoring and impact prediction step can assign risk levels to detected vulnerabilities based on severity and exploitability using a Common Vulnerability Scoring System (CVSS) to assign risk levels.

### The Target Network Analyzer

FIG. 7 shows steps for the implementation of the virtual model of the target network with annotated layer descriptions. Annotating layers of the virtual network that model the target network involves creating overlay virtual networks, for example, using Hyper-V network virtualization. Hyper-V Network Virtualization allows hosting providers to host customer virtual machines (VMs) without requiring changes to the physical network topology. It provides the concept of a VM Network independent of the underlying physical network, allowing virtual machines to be attached to a virtual network without being tied to a specific location in the physical network. This technology enables the virtualization of network resources and allows multiple virtual networks to run in isolation, acting as separate physical networks. It simplifies multi-tenancy and VM migrations across different physical networks.

As shown in FIG. 7, the implementation of the virtual model can involve capturing the target network's topology by documenting IP address assignments, VLANs, subnet masks, routing tables, and firewall rules before identifying core network services (e.g., DNS, Dynamic Host Configuration Protocol (DHCP) authentication servers). The second step involves building the virtual network in the cloud by 1) selecting a Cloud Provider, such as AWS (VPC), Azure (VNets), or Google Cloud (VPC), 2) defining network addressing using similar IP ranges and subnets, 3) deploying virtual appliances by installing cloud-based routers, firewalls, and security appliances, and 4) implementing access control configuring security groups, NACs, and IAM policies. The third step involves establishing connectivity by 1) Site-to-Site VPN or Direct Peering for securely bridging on-premises and cloud networks, 2) Border Gateway Protocol (BGP) Peering for enabling dynamic routing between physical and virtual networks, and Cloud network address translation (NAT) for providing external connectivity for private subnets. The fourth step involves testing and validation by 1) simulating traffic and load to ensure performance and latency match expected values, 2) monitoring with cloud tools, such as AWS CloudWatch, Azure Network Watcher, or GCP Stackdriver, and 3) fine-tuning security policies to validate firewall rules, segmentation, and access control.

The target network analyzer can be configured to determine vulnerabilities based on the cyber-attack records and target network vulnerabilities. For example, the target network analyzer can be configured to inspect the target network for a target vulnerability from a vulnerability detection algorithm, access MITRE records in the database, determine a corresponding vulnerability in the target network that is also in the records to assess mitigation action for the target vulnerability.

### Virtual Network Generator

The “virtual network generator” may leverage cloud virtualization platforms, such as AWS Virtual Private Cloud (VPC), Microsoft Azure Virtual Network, Google Cloud VPC, or Hyper-V. These virtual networks may mirror the physical topology by replicating subnets, firewall rules, routing tables, MAC address assignments, and annotated node attributes. Each node in the virtual network may be annotated with structured metadata, including device role, criticality, vulnerability class, OSI layer, and historical attack events.

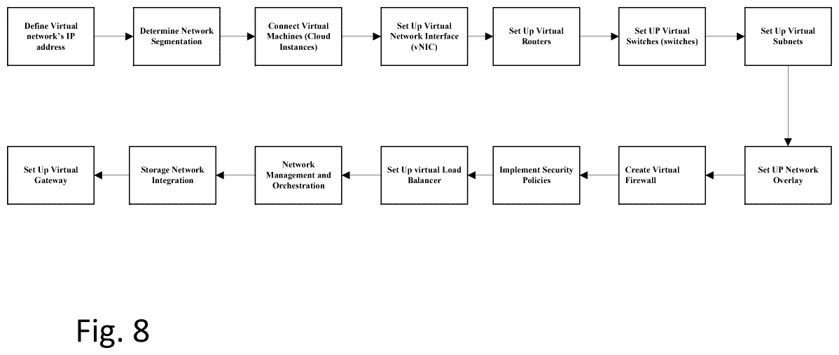

FIG. 8 shows flow chart used generating a model of the target network based on the target network topology by first defining the virtual network's IP address (e.g., 192.168.1.0/24) and determining the number of subnets that may be needed for different network segments (e.g., web servers, database servers, internal applications) before deploying the virtual network's infrastructure. Such deployment may require setting up virtual machines that create instances of network components that emulate physical components. For example, virtual network interfaces (vNIC) are set up, which act as the virtual equivalent of physical network interface cards (NICs) used for connecting virtual machines (VMs) or containers to the virtual network, thereby enabling data transmission and reception by assigning MAC addresses, supporting bandwidth allocation, and integrating with higher-layer protocols (e.g., IP). Virtual Routers are set up that emulate a physical router to handle inter-network communication by routing traffic between different virtual subnets or networks, supporting Network Address Translation (NAT), and managing IP addressing as well as dynamic routing protocols (e.g., OSPF, BGP), firewall rules, and gateway services. Virtual Switches (vSwitches) are set up to mimic, for example, a physical Ethernet switch to manage traffic between virtual devices by forwarding packets between vNICs, supporting VLAN tagging, and enforcing network policies. Other features of vSwitches are port grouping, traffic segmentation, and integration with virtual network overlays. Network segmentation is configured by setting virtual subnets that separate traffic. The virtual subnets replicate the segmentation of a physical network into smaller broadcast domains by assigning |IP address ranges to groups of virtual devices, which ensures logical isolation. DHCP for IP allocation, subnet masks, and connectivity to virtual routers are other features of network segmentation.

As a part of network annotation, network overlays can be set up to provide layers of abstraction over the underlying physical infrastructure, which enables virtual networks to span multiple physical hosts using encapsulation protocols (e.g., VXLAN, GRE). A virtual firewall is set up as a physical firewall for security and traffic control by filtering traffic based on rules, protecting virtual workloads, and unauthorized access. The virtual firewall provides stateful inspection, intrusion detection, and integration of virtual routers or switches. Security policies can be implemented by Access Control Lists (ACLs), which restrict communications between subnets. Network security and connectivity can be implemented, for example, via VPN and Virtual Private Cloud (VPC) peering, which can securely connect remote branches, mimicking private leased lines. A network management and orchestration functional block can replicate the control plane of the target network for configuration and monitoring by managing virtual network components, automating provisioning, and ensuring implementation of policies using the centralized dashboard, APIs for integration, and telemetry for performance monitoring. A virtual storage network can mimic dedicated storage networks (e.g., SAN) in the target network's setup by connecting virtual machines to virtualized storage resources over protocols like iSCSI or NFS using QoS for storage traffic, latency optimization, and redundancy. A virtual gateway can be set up to bridge the virtual network to external physical networks or the internet by handling egress/ingress traffic, supporting VPNs, and ensuring connectivity to outside resources using IPsec tunneling, public IP mapping, and protocol translation.

The network analyzer can be configured to correlate vulnerabilities determined by the target network inspector with attacks in the cyber-attack logs by matching vulnerability inspection findings with known cyber-attacks against the target network.

### Triage Module

The target network analyzer may comprise a triage module configured to assign risk scores to vulnerabilities based on probability of breach, business impact, exploit availability, or regulatory risk, time to repair, cost to repair, cost if compromised, etc. The triage module is configured to measure relative significance of two or more vulnerability in the target network; and rank the vulnerabilities in a repair order. For example, the triage module can be configured to prioritize and categorize vulnerabilities based on multiple risk factors, such as:
1. Time to Repair (TTR)—The estimated duration that may be required to fix a vulnerability (short, medium, long).
2. Cost to Repair (CTR)—The financial or resource expense needed for mitigation.
3. Probability of Breach (PoB)—The likelihood of exploitation by threat actors.
4. Business Impact (BI)—The potential damage to business operations if exploited.
5. Exploit Availability (EA)—Whether public exploits exist (e.g., known zero-day vulnerabilities).
6. Regulatory Compliance Risk (RCR)—Legal or compliance implications of an unpatched vulnerability.
   Alternatively, the “risk scoring model” in the triage module can use a weighted algorithm:

$$Risk Score = ( PoB \times 0.4 ) + ( BI \times 0.3 ) + ( EA \times 0.2 ) + ( RCR \times 0.1 ) ,$$

where:
PoB is the Probability of Breach, determined through predictive modeling;
BI is the Business Impact, reflecting asset sensitivity and operational dependency;
EA is the Exploit Availability, based on CVE databases and exploit kits;
RCR is the Regulatory Compliance Risk, based on frameworks such as GDPR, HIPAA, and NIST.

For example, the triage process for decision-making can involve vulnerability ingestion when collected vulnerability data is matched against the database records before risk scoring when each vulnerability is scored using a weighted formula that considers multiple factors where:
PoB (40%) has the highest weight, as the likelihood of exploitation is critical.
BI (30%) is the next priority, as business damage is a significant concern.
EA (20%) determines if the vulnerability is actively being exploited.
RCR (10%) ensures compliance with legal frameworks like GDPR, HIPAA, etc.

Based on the risk score, vulnerabilities can be classified into the following example categories shown in Table 7:

TABLE 7

| Risk Score | Priority Level | Action Required |
|---|---|---|
| 8.0-10.0 | Critical | Immediate patching or network isolation |
| 6.0-7.9 | High | Patch within 24-48 hours |
| 4.0-5.9 | Medium | Fix within a scheduled maintenance window |
| 0.0-3.9 | Low | Monitor but defer remediation |

Table 8 below is an example output from the triage module:

TABLE 8

| Vulnerability ID | TTR | | CTR ($) | PoB (%) | BI | EA | RCR | Risk Score | Priority |
|---|---|---|---|---|---|---|---|---|---|
| CVE-2025-1234 | 24 | h | 1000 | 90 | 9 | 8 | 5 | 8.9 | Critical |
| CVE-2025-5678 | 48 | h | 750 | 75 | 7 | 6 | 7 | 7.2 | High |
| CVE-2025-9101 | 72 | h | 500 | 50 | 5 | 3 | 4 | 5.6 | Medium |
| CVE-2025-4321 | 1 | week | 200 | 30 | 3 | 2 | 2 | 3.2 | Low |

Automated response and mitigation suggestions may be made based on the module output.
If critical, the module triggers alerts and auto-implements security controls (e.g., firewall rule updates).
If it is a high priority, it assigns tasks to security engineers.
If it is medium/low priority, it logs the issue for future patching.

### The Virtual Network

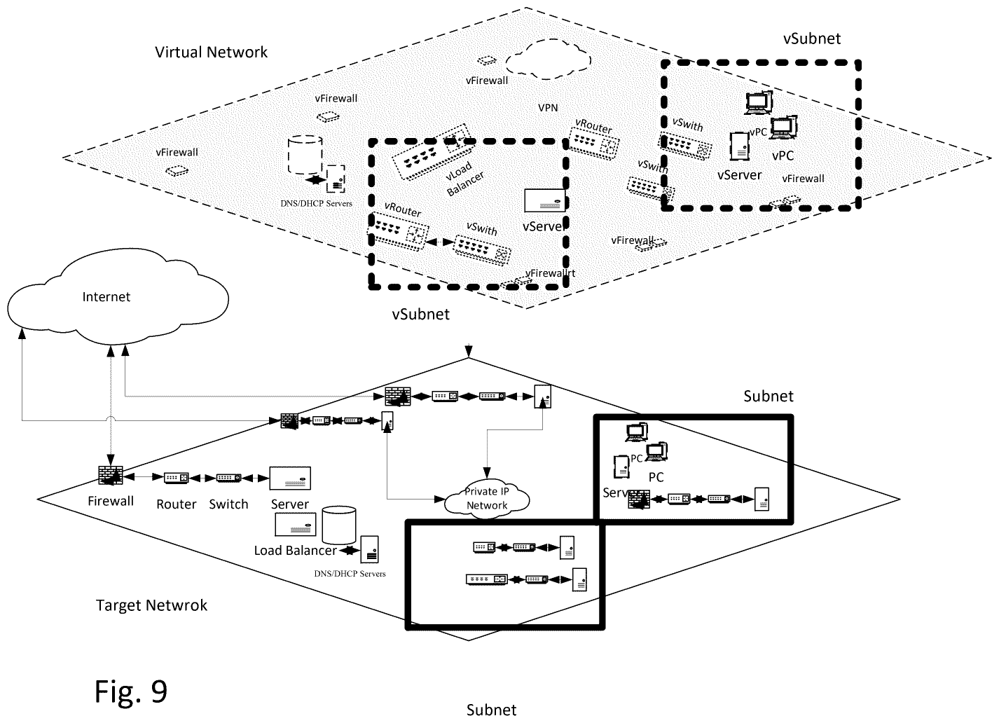

FIG. 9 shows a conceptual illustration of virtual network components and their physical network equivalents according to Table 9 below.

TABLE 9

| Virtual Network | Physical Network | |
|---|---|---|
| Component | Equivalent | Function |
| Virtual Switch (vSwitch) | Physical Ethernet Switch | Connects virtual machines (VMs) or cloud instances within the |
| | | network. |
| Virtual Router | Physical Router | Routes traffic between subnets and external networks. |
| Virtual Firewall | Physical Firewall | Implements security rules to filter network traffic. |
| Virtual Subnet | VLANs (Virtual LANs) | Segments the network for different workloads or applications. |
| Virtual Private Network | Leased Line/MPLS | Securely connects remote locations over the internet. |
| (VPN) | | |
| Load Balancer | Hardware Load Balancer | Distributes traffic across multiple virtual servers. |
| DNS & DHCP Services | On-Premises DNS/DHCP | Resolves domain names and assigns IP addresses dynamically. |
| | Servers | |

### Virtual Cyber Defense System

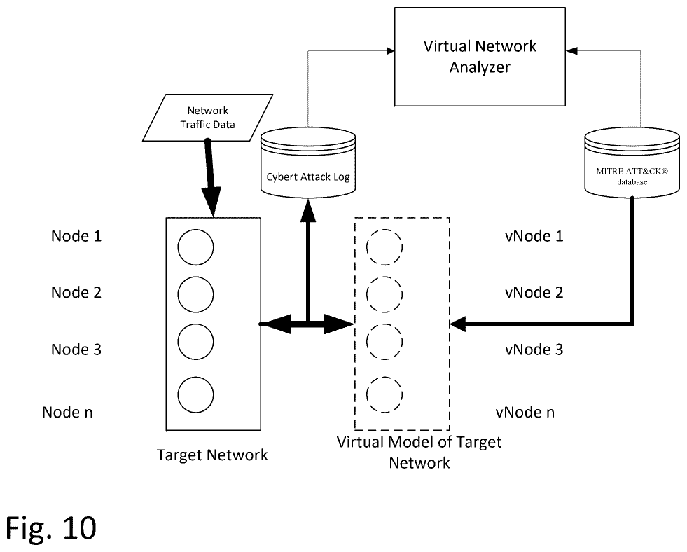

FIG. 10 shows a block diagram of the architecture of an integrated virtual cyber defense system (the VCDS). The VCDS is built on main components that work together for automated attack detection and response, namely, 1) the virtual network, which replicates the target network, 2) the cyber-attack log database, which stores past attack incidents detected in the target network, 3) MITRE ATT&CK® database, which provides real-world threat intelligence, attack techniques, and adversary behavior data, and 4) the virtual network analyzer, which interfaces with the virtual network. The virtual network analyzer has a vulnerability detection algorithm configured to determine vulnerabilities in the compromised network; and use the records of target network vulnerabilities to improve and update the vulnerability detection algorithm.

As shown, the virtual network analyzer interfaces with the virtual network, cyber-attack logs database, and the MITRE ATT&CK® TTP database. The target network is comprised of 1-n Nodes. The virtual network includes 1-n virtualized nodes corresponding to 1-n Nodes. The virtual network is a comprehensive, attack-aware model of the target network created by (1) building an accurate, multi-layer representation of assets, connectivity, protocols, controls and (2) annotating one or more layers with corresponding threat surface, common attack vectors, and mitigations. According to the present specification, one or more nodes are annotated with cyber-attacks. In networking, annotation means adding structured metadata or explanatory notes to network elements (devices, links, flows, policies, logs, etc.) so that each component carries extra context beyond its raw technical configuration. For example, annotation can directly link vulnerabilities when aligned with standards like MITRE ATT&CK and CVSS.

| Target Object | Annotation Example | Purpose |
|---|---|---|
| Log Entry | attack_id = T1190; layer = | Map events to |
| | Application; vuln = | known techniques/ |
| | CVE-2023-1234 | vulnerabilities |

One example of virtual node annotation involves recording, for example, 1) node identity, 2) role, 3) criticality (low/medium/high), 4) attack types (e.g., reconnaissance, exploitation, privilege escalation), 5) MITRE technique ids, 6) attack vector (phishing, port scan, SQL injection, etc.), 7) likelihood (low/medium/high), 8) impact (confidentiality, integrity, availability rating), 9) existing controls and 10) recommended mitigations. Maintenance of cyber-attack logs in the database can serve as valuable data for detecting trends, improving defenses, and automating response strategies. Table 10 shows the annotation of various nodes based on attack types.

TABLE 10

| | | Criti- | | MITRE | | Likeli- | Impact | | Recommended |
|---|---|---|---|---|---|---|---|---|---|
| Node | Role | cality | Attack Type | TTP | Vector | hood | (C-I-A) | Controls | Mitigation |
| Firewall | Perimeter | High | Denial-of- | T1499 | UDP flood | Medium | L-M-H | Rate | Geo-blocking, |
| | enforcement | | Service | | | | | limiting, | anomaly |
| | | | | | | | | ACLs | detection |
| Web | Public- | High | Remote Code | T1190 | SQL injection | High | H-H-M | WAF, input | WAF tuning, |
| Server | facing | | Execution | | | | | validation | vulnerability |
| | application | | | | | | | | patching |
| Database | Sensitive | High | Data | T1020 | Misconfigured | Medium | H-H-M | Encryption | Tighten ACLs, |
| Server | data store | | Exfiltration | | ACL | | | at rest, | DLP solution |
| | | | | | | | | RBAC | |
| Layer-2 | Internal | Medium | ARP | T1557 | Local network | Medium | M-M-L | Dynamic | Port security, |
| Switch | segmentation | | Poisoning | | spoofing | | | ARP | NAC |
| | | | | | | | | inspection | |
| User | Endpoint | Medium | Credential | T1003 | Phishing/email | High | H-M-L | Antivirus, | Endpoint |
| Workstation | computing | | Theft | | | | | MFA | detection & |
| | | | | | | | | | response (EDR) |

According to the present specification, the virtual network communicates with the cyber-attack logs database and the reference MITRE ATT&CK TTP database in real-time to create a self-learning cybersecurity ecosystem. This setup allows the virtual network analyzer to detect, analyze, and defend against emerging cyber threats based on attack patterns from at least one historical data and global threat intelligence information. Table 11 below shows how the MITRE ATT&CK® dataset can be integrated with records in the attack log database based on Attack_ID.

TABLE 11

| Column Name | Data Type | Description |
|---|---|---|
| Attack_ID | INT (Primary Key) | Unique identifier for the attack. |
| Timestamp | DATETIME | Date and time of the attack. |
| Attack_Type | VARCHAR(255) | Type of attack (e.g., Phishing, Ransomware, DDoS). |
| MITRE_Tactic | VARCHAR(255) | ATT&CK Tactic (e.g., Initial Access, Lateral Movement). |
| MITRE_Technique | VARCHAR(255) | Specific attack method (e.g., Exploit Public-Facing Application). |
| Source_IP | VARCHAR(45) | IP address of the attacker. |
| Destination_IP | VARCHAR(45) | Target IP within the physical network. |
| Affected_System | VARCHAR(255) | The compromised host or service. |
| Impact_Level | ENUM (‘Low’, ‘Medium’, | Severity of the attack. |
| | ‘High’, ‘Critical’) | |
| Action_Taken | VARCHAR(255) | Mitigation steps (e.g., Blocked IP, Reset Passwords). |

The VCDS of FIG. 10 performs live traffic analysis in the virtual network to detect potential threats. The system queries MITRE ATT&CK for known attack techniques to match the detected activity before checking the attack log database to determine if similar attacks have happened in the past. The system retrieves attack details if a match is found in MITRE ATT&CK, including 1) Tactics, Techniques, and Procedures (TTPs) used by adversaries, 2) detection methods and possible mitigations, and 3) related threat actors known to use the attack technique. If an attack matches a previous case in the attack log database, the system checks how it was mitigated before. The system automatically generates firewall rules, IDS alerts, or SIEM correlation rules to prevent attack progression. If an attack is successfully blocked, the system updates the attack log database, and threat intelligence feeds are refreshed with newly discovered attack methods. In this way, the virtual network adapts in real time, improving resilience against future attacks.

The VCDS can use Artificial Intelligence (AI) and Machine Learning (ML) for threat pattern detection, where machine learning models can analyze historical attack data to detect anomalies. In order to mitigate cyber-attacks, the system can be trained to match cyber-attack techniques to specific network layers (node layers). More specifically, the system learns from historical attack logs, MITRE ATT&CK threat intelligence, and network topology data to identify the layer-wise vulnerabilities being exploited. The AI training pipeline can comprise multiple blocks, from data collection to real-time attack classification.

### AI/ML Implementation

FIG. 11 shows functional block diagram that implements an AI engine for threat pattern detection. The AI engine may include one or more models selected from the group comprising: decision trees, support vector machines, deep neural networks, convolutional neural networks, graph neural networks, and transformer-based architectures. Feature inputs may include protocol headers, payload entropy, packet frequency, historical threat vectors, MITRE ATT&CK technique mappings, and system log anomalies. Training data for the AI engine may comprise labeled cyber-attack incidents collected from the cyber-attack log database, and external threat feeds aligned with the TTP database. The training data can include at least one of structured data, such as network logs, and unstructured data, such as security incident reports and the AI engine can be retrained in response to newly detected attack patterns.

A data collection and preprocessing step aggregates cybersecurity data from multiple sources to train the AI model. Such data sources include the attack log database (past incidents, attack types, timestamps, affected nodes), MITRE ATT&CK framework (TTPs-Tactics, Techniques, and Procedures), network traffic logs (packet captures, IDS/IPS logs, firewall logs) and network topology data (layered model of devices, IPs, VLANs, protocols). Processing tasks standardize IP headers and protocol data, attack metadata, and clean and normalize data for ML training. A feature engineering step extracts relevant features. An attack layer mapping step links cyber-attacks with one or more OSI layers. For example, packet-level analysis can identify targeted protocols (e.g., HTTP, TCP, ICMP), traffic behavior analysis can examine latency, volume, and frequency anomalies, attack Signature recognition can match payload patterns with known attack techniques and network node inference can identify which network layer is compromised. As a result, a structured dataset with labeled attack-layer mappings can be used for AI training. A machine learning model training step builds and trains a selected AI model to predict which OSI layer a cyber-attack is targeting using various approaches. Supervised learning can use labeled attack logs to train the AI model. Unsupervised learning can detect unknown attack patterns through anomaly detection. Reinforcement learning can adapt to new attack techniques. Models used for training can include 1) Random Forest/Decision Trees for rule-based attack classification, 2) Deep Neural Networks (DNNs) for complex, multi-layer attack analysis, and 3) Graph Neural Networks (GNNs) for mapping attacks to network node relationships. For example, GNNs can be used for network node mapping or anomaly detection via autoencoders. The AI engine comprises a deep neural network trained to classify attack types by OSI layer based on packet metadata, protocol behavior, and attack signatures.

As a result, a trained model capable of mapping attacks to network layers in real-time can be created. In an attack detection step, the trained AI model analyzes real-time traffic and matches detected attacks to OSI layers based on process flows, including 1) live data ingestion, when the AI system monitors network traffic, and 2) feature extraction, which extracts protocols, signatures, and metadata from packets. Using a prediction engine in a real-time classification step, the AI classifies the attack, determines the compromised OSI layer, and generates firewall rules, IDS alerts, or access controls. The AI system learns from new attacks and defenses. Using a feedback loop, new attack incidents are logged into the training dataset, and the AI model is retrained using updated attack tactics from MITRE ATT&CK.

An AI framework for training the cybersecurity system is selected by evaluating the performance, scalability, compatibility, and security of different machine learning (ML) and deep learning (DL) frameworks. Table 13 shows functional blocks for framework selection.

TABLE 12

| Block | | |
|---|---|---|
| No. | Functional Block | Purpose |
| 1 | Problem Definition & Requirements | Define use case (e.g., attack-layer classification), data availability, and model goals. |
| | Analysis | |
| 2 | Algorithm Compatibility Check | Ensure framework supports required ML/DL algorithms (e.g., Random Forest, CNNs, |
| | | Transformers). |
| 3 | Data Handling & Processing Capabilities | Check framework's ability to handle large-scale network traffic & cybersecurity logs. |
| 4 | Scalability & Performance | Evaluate speed, memory consumption, and ability to process real-time network data. |
| | Benchmarking | |
| 5 | Framework Security & Compliance | Ensure compliance with security policies, encryption standards, and regulatory needs. |
| 6 | Ease of Integration with Existing | Assess compatibility with SIEM, IDS, SOAR, and cloud/network monitoring tools. |
| | Systems | |
| 7 | Community Support & Documentation | Choose frameworks with active developer communities, updates, and extensive |
| | | documentation. |

More specifically, selecting the training framework involves identifying the cybersecurity problem (e.g., OSI layer attack detection) and determining structured & unstructured data types (packet captures, logs, real-time telemetry) for real-time AI processing. For example, TensorFlow can be used for strong Description Logic (DL) support and real-time inference. PyTorch can be used for flexibility in cybersecurity models. Scikit-Learn can be used for classical ML models like decision trees. Other training frameworks include Theano, Microsoft CNTK, Apache Mahout, Amazon Machine Learning, Jax, and Caffe.

Upon detecting threats, the system can broadcast alerts and implement defenses by automatically responding to attacks in real time. Table 14 below shows functional blocks for alert broadcasting and defense implementation.

TABLE 13

| Block | | |
|---|---|---|
| No. | Functional Block | Purpose |
| 1 | Threat Detection & Classification | Identifies cyber threats based on logs, network traffic, and AI analysis. |
| 2 | Alert Generation & Prioritization | Classifies alerts by severity and urgency (e.g., Critical, High, Medium, Low). |
| 3 | Broadcasting Alerts to Security Teams & | Notifies SOC teams, IT administrators, and incident response platforms. |
| | Systems | |
| 4 | Security Orchestration & Automated | Uses SOAR (Security Orchestration, Automation, and Response) to trigger pre- |
| | Response | defined actions. |
| 5 | Active Threat Containment & Mitigation | Implements real-time firewall rule updates, user session termination, and network |
| | | segmentation. |
| 6 | Threat Intelligence & Forensics Logging | Logs attack details for future analysis, compliance, and AI-driven improvements. |

More specifically, the AI-powered detection systems analyze logs, network packets, and security events and use threat intelligence feeds, such as MITRE ATT&CK, VirusTotal, and Alien Vault OTX, to classify attack types. SIEM (Splunk, ELK, Microsoft Sentinel) aggregates and correlates events. For example, if an RDP brute-force attack targeting a Windows server is detected, the system matches the attack pattern to MITRE ATT&CK T1078 (Valid Accounts Misuse) and assigns risk level Critical if admin access is compromised. Alerts can be categorized based on severity, affected systems, and potential impact, for example, with the following alert levels:
Critical-Immediate action required (e.g., ransomware detected).
High-Active exploit attempt (e.g., SQL injection).
Medium-Potential risk detected (e.g., brute force attempt).
Low-Suspicious activity that needs monitoring.

Once AI-driven cybersecurity algorithms are deployed, they can map attacks to network layers, analyze past threats, and simulate “what-if” scenarios to predict potential future attacks. The cyber-attack simulation can be based on at least one of cyber-attacks on networks other that the target network, such as those derived from real-world threat intelligence as recoded in the reference database and historical cyber-attacks against the target network as recoded in the cyber-attack log database.

The system evaluates vulnerabilities, tests different attack scenarios, and optimizes defensive responses. A recommendation engine can be configured to generate prioritized mitigation actions based on simulation outcomes. A scoring engine can score each vulnerability using a triage model that incorporates probability of breach, business impact, exploit availability, and regulatory compliance risks.

### What-if-Scenario Implementation

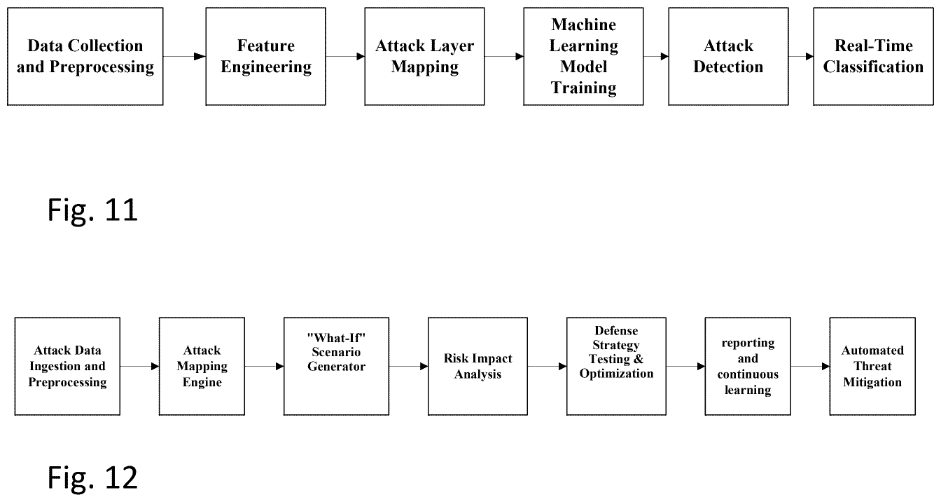

The virtual network analyzer simulates “what-if” scenarios to model potential future attacks and identify optimal defense strategies. FIG. 12 shows functional blocks for mapping attacks and running “what-if” scenarios. More specifically, in an attack data ingestion and preprocessing step, real-time attack feeds can be received from SIEM (Splunk, Sentinel, ArcSight) before MITRE ATT&CK correlation to match techniques & tactics followed by extracting network logs & traffic patterns for analysis. For example, if a DDOS attack is detected on a web application, logs show unusual spikes in HTTP requests from multiple IPs. An attack mapping engine can use AI classifiers & MITRE ATT&CK datasets to map the attack before identifying OSI layer(s) affected and adversary techniques, followed by predicting possible lateral movement based on previous attack trends. For example, AI can map the DDOS attack to OSI Layer 7 (Application Layer) and identify the attack type as T1498, i.e., Network Denial of Service. A “What-If” Scenario Generator AI simulates variations of the attack under different conditions, such as
What if the attacker used a botnet with 1000× more traffic?
What if the attack shifts from Layer 7 to Layer 3 (volumetric flood attack)?

Different attack paths can be tested using game theory models. For example, AI can simulate a future DDOS escalation if firewall rules remain unchanged and determine if the attack could bypass rate-limiting defenses if the botnet scales. A risk impact analysis step can calculate attack impact scores based on historical data, business impact, and system vulnerabilities before assigning risk levels (Low, Medium, High, Critical), followed by identifying the most vulnerable attack surfaces. For example, AI can predict website downtime of 3 hours if no mitigation is applied and assigns DDOS risk as HIGH for exposed servers. A defense strategy testing and optimization step can test alternative defense mechanisms (e.g., rate limiting, geo-blocking, anomaly-based filtering) before running AI-driven attack-response playbooks, followed by selecting optimal security measures based on cost-benefit analysis. For example, AI can test three DDOS mitigation strategies, namely, 1) rate limiting, which can work but could impact legitimate users, 2) geo-blocking, which can block attacks, but VPN-based attacks could still get through; or 3) AI-based filtering, which can be the best defense by detecting anomalies in HTTP request patterns. An automated threat mitigation step can update security policy by deploying firewall rules, intrusion prevention (IPS), and network segmentation, adjusting SIEM alerting policies to prioritize similar attacks, and implementing zero-trust measures (e.g., MFA, role-based access control). For example, AI can automatically update WAF rules to block malicious botnet requests, and SIEM can flag unusual traffic spikes earlier for proactive blocking. A reporting and continuous learning step can store attack scenarios and responses for post-incident analysis. AI models can be updated to improve future threat detection, and compliance reports (NIST, ISO 27001, GDPR, SOC 2) can be generated. For example, AI can log “What-If” scenario outcomes for future AI model training and generate risk reports showing reduced downtime by 70% after mitigation.

A simulation engine can simulate one or more cyber-attacks against the virtual model using historical attack records and TTP data. Simulation results can be analyzed using an AI engine to identify exploited vulnerabilities and corresponding OSI layers.

### Network Updater

The virtual network analyzer may transfer an updated vulnerability detection algorithm to the target network analyzer. Once it receives an updated vulnerability detection algorithm, the target network analyzer may be configured to update its vulnerability detection algorithm. The target network analyzer may also be configured to determine a corresponding vulnerability in the target network in the records. The target network analyzer may comprise a recommendation engine configured to generate a list of recommendations to improve the target network's security. The recommendation engine can generate mitigation suggestions selected from the group comprising user lockout, patch deployment, segmentation enforcement, credential revocation, and traffic throttling. The recommendation engine can be configured to generate prioritized mitigation actions based on simulation outcomes. Also, the network updater may implement mitigation action changes including 1) automatic application of security patches, 2) firewall rule modification, 3) role-based access control (RBAC) enforcement, 4) session termination and credential reset, 5) VLAN reassignment for network quarantine; and 6) dynamic segmentation or geofencing, 7) disabling a compromised account, 8) altering user access rights, or 9) isolating a vulnerable node. Additionally, the mitigation action changes can include 1) changing a firewall setting; 2) changing a setting on a terminal in the target network; 3) changing settings on a user's rights; or 4) instituting a lockdown protocol.

### Hardware Configurations

Various system components (such as the target network analyzer, virtual network analyzer, etc.) may include a hardware processor communicatively coupled to an instruction memory and a data memory by a bus. The instruction memory can be configured to store executable program code on at least a non-transitory computer-readable medium, as described in greater detail below. The hardware processor may include multiple hardware processors and/or multiple processor cores. The hardware processor may comprise cooperation with hardware processors from different devices. The server, hub, and endpoint may execute one or more basic instructions in the executable program code. The server, hub, and endpoint can include a network interface communicatively connected to the bus for interfacing to a local area network (LAN). It may connect to a wide area network (WAN), e.g., the Internet or a private area network. Also, a GUI can be communicatively connected to the bus. The components shown in FIG. 1 may also include data storage accessible to the hardware processor via the bus.

The relationship between the executable program code of the system components (including the operating system) and the system hardware processor is structural. The executable program code is provided to the hardware processor by imparting various voltages at specific times across certain electrical connections, according to binary values in the executable program code, to cause the hardware processor to perform some action, as explained in more detail.

A hardware processor may be considered a complex electrical circuit configured to perform a predefined set of basic operations in response to receiving a corresponding basic instruction.

The predefined native instruction set of executable program codes is specific to the hardware processor; the processor's design defines the collection of basic operational logic to which the hardware processor will respond throughout the screening workflow, and this collection forms the predefined native instruction set of codes.

A basic instruction may be represented numerically as a series of binary values, which is also known as machine code. The series of binary values may be represented electrically as inputs to the hardware processor via electrical connections, using voltages representing either a binary zero or a binary one. The hardware processor interprets the voltages as binary values.

Executable program code may, therefore, be understood to be a set of machine codes selected from the predefined native instruction set of codes. Generally, a given set of machine codes may be understood to constitute a module. A set of one or more modules may be understood to constitute an application program or “app.” An app may interact with the hardware processor directly or indirectly via the middleware. An app may be part of the middleware.

### CONCLUSION

As described above, a robust, multi-layered AI/ML-based cybersecurity system offers automated detection, mitigation, and continuous learning capabilities. More specifically, the system creates a real-time, self-learning cybersecurity ecosystem that uses virtual replicas of real networks (digital twins) to simulate and analyze threats. A hybrid AI/ML framework trained on historical cyber-attack data from a custom attack log database and MITRE ATT&CK TTP intelligence. The system provides automated vulnerability detection, triage, and remediation, including real-time firewall and access control updates. A What-if” attack simulation engine, enables preemptive defense planning using game-theoretic modeling. The integration of a target network inspector, virtual network analyzer, TTP database (e.g., MITRE ATT&CK), and attack log DB. A network updater can autonomously reconfigure the network based on AI-generated recommendations. A triage engine can use a scoring algorithm considering PoB, BI, EA, and RCR. An AI/ML architecture provides layer-specific attack classification using AI to map OSI layers to threat signatures Reinforcement learning components adapt to new threats. Annotated virtual network nodes are enriched with metadata for attack detection. The system also uses simulated “What-If” scenarios by incorporation of probabilistic modeling and impact forecasting in virtual environments, attack vector escalation simulation and adaptive mitigation based on AI optimization.

The system described herein may be implemented as a combination of hardware and software. Each module referenced—such as the AI engine, triage module, virtual network analyzer, and network updater—may be instantiated as a software routine executing on a general-purpose processor, or as a dedicated hardware implementation such as an ASIC, FPGA, or embedded system.

To the extent the subject matter has been described in language specific to structural features or methodological steps, it will be understood that the subject matter defined in the appended claims is not necessarily limited to the specific features or steps described. Rather, the specific features and steps are disclosed as examples of forms of implementing the claimed subject matter. To the extent headings appear in this description, they are for the convenience of the reader, not as limitations or restrictions of the systems, techniques, approaches, methods, or devices to those appearing in any section. Rather, the teachings and disclosures herein can be combined or rearranged with other portions of this disclosure and the knowledge of one of ordinary skill in the art. This disclosure generally encompasses and includes such variation. The indication of any elements or steps as “optional” does not indicate that all other or any other elements or steps are mandatory. The claims define the invention and form part of the specification. Limitations from the written description are not to be read into the claims.

Certain attributes, functions, steps of methods, or sub-steps of methods described herein may be associated with physical structures or components, such as a module of a physical device that, in implementations in accordance with this disclosure, make use of instructions (e.g., computer-executable instructions) that may be embodied in hardware, such as an application-specific integrated circuit, or that may cause a computer (e.g., a general-purpose computer) executing the instructions to have defined characteristics. There may be a combination of hardware and software, such as a processor implementing firmware, software, and so forth, to function as a special-purpose computer with the ascribed characteristics. For example, in embodiments, a module may comprise a functional hardware unit (such as a self-contained hardware or software or a combination thereof) designed to interface the other system components, such as through an application programming interface (API). In embodiments, structures for a module a module can be according to the module's function or set of functions, e.g., by a described algorithm. This disclosure may use nomenclature that associates a component or module with a function, purpose, step, or sub-step to identify the corresponding structure, which sometimes includes hardware and/or software that function for a specific purpose.

Titles and headings used throughout the specification are provided for navigational purposes only. They should not be considered limiting or defining the subject matter disclosed. Paragraphs and sections relevant to one figure or embodiment may be equally applicable to another figure.

While specific implementations have been described, these implementations have been presented by way of example only and are not intended to limit the scope of this disclosure. The novel devices, systems, and methods described herein may be embodied in a variety of other forms; furthermore, various omissions, substitutions, and changes in the form of the devices, systems, and methods described herein may be made without departing from the spirit of this disclosure.

The claimed invention is:

1. A system for mitigating cyber-attacks against a target network comprising interconnected nodes that is implemented by Open Systems Interconnection (OSI) layers, comprising:
a target network inspector configured to monitor the target network for detecting vulnerabilities at one or more OIS layers;
a cyber-attack log database containing records of successful cyber-attacks on the target network;
a virtual network generator configured to generate a virtual network comprising a virtualized model of the target network, including one or more virtual nodes annotated with identified vulnerabilities of one or more corresponding nodes of the target network;
a reference database configured to store records of known cyber-attacks and their corresponding mitigations.
a virtual network analyzer configured to simulate cyber-attacks on the virtual network based on records of known cyber-attacks and successful cyber-attacks.
an AI engine configured to generate one or more mitigation actions based on simulation of the cyber-attacks on the virtual network; and
a network updater configured to implement the one or more mitigation actions on the target network.

2. The system of claim 1, wherein the one or more mitigation actions comprise at least one of: 1) application of a security patch, 2) modification of a firewall rule, 3) a role-based access control (RBAC) enforcement, 4) a session termination 5) altering a user's access rights, 6) isolating a node; 7) disabling a compromised use account; and 8) instituting a lockdown protocol.

3. The system of claim 1, wherein simulation of the cyber-attacks on the target network are based on at least one of data associated with cyber-attacks against one or more networks other than the target network and data associated with past cyber-attacks against the target network.

4. The system of claim 1, wherein the AI engine comprises a deep neural network trained to classify attack types by an OSI layer.

5. The system of claim 1, wherein a cyber-security threat alert is generated categorized by one or more severity levels.

6. The system of claim 1, wherein training data for the AI engine includes at least one of structured data and unstructured data associated with cyber-attacks.

7. The system of claim 1, wherein records of successful cyber-attacks includes at least one of a timestamp, a source, and an attack vector.

8. The system of claim 1, further comprising a triage module configured to assign risk scores to the vulnerabilities.

9. The system of claim 1, wherein a triage module uses a weighted scoring formula to assign a risk score to a vulnerability based on at least one of probability of breach, business impact, exploit availability, or regulatory risk.

10. The system of claim 1, wherein the virtual network analyzer simulates what-if scenarios based on the one or more mitigation actions.

11. A method for mitigating cyber-attacks against a target network comprising interconnected nodes that is implemented by Open Systems Interconnection (OSI) layers, comprising:
monitoring the target network for detecting vulnerabilities at one or more OIS layers;
accessing a cyber-attack log database containing records of successful cyber-attacks on the target network;
generating a virtual network comprising a virtualized model of the target network, including one or more virtual nodes annotated with identified vulnerabilities of one or more corresponding nodes of the target network;
accessing a reference database configured to store records of known cyber-attacks and their corresponding mitigations.
simulating cyber-attacks on the virtual network based on records of known cyber-attacks and successful cyber-attacks.
generating one or more mitigation actions based on simulation of the cyber-attacks on the virtual network using an AI engine; and
implementing the one or more mitigation actions on the target network.

12. The method of claim 11, wherein the one or more mitigation actions comprise at least one of: 1) automatic application of security patches, 2) firewall rule modification, 3) role-based access control (RBAC) enforcement, 4) session termination 5) altering user access rights, 6) sub-isolating a vulnerable node; 7) disabling a compromised account; and 8) instituting a lockdown protocol.

13. The method of claim 11, wherein a simulation of the cyber-attacks on the target network are based on at least one of data associated with cyber-attacks against one or more networks other than the target network and data associated with past cyber-attacks against the target network.

14. The method of claim 11, wherein the AI engine comprises a deep neural network trained to classify attack types by an OSI layer.

15. The method of claim 11, wherein a cyber-security threat alert is generated categorized by one or more severity levels.

16. The method of claim 11, wherein training data for the AI engine includes at least one of structured data and unstructured data associated with cyber-attacks.

17. The method of claim 11, wherein the records of successful cyber-attacks includes at least one of a timestamp, a source, and an attack vector.

18. The method of claim 11, further comprising performing a triage to assign risk scores to the vulnerabilities.

19. The method of claim 11, wherein a triage uses a weighted scoring formula to assign a risk score to a vulnerability based on at least one of probability of breach, business impact, exploit availability, or regulatory risk.

20. The method of claim 11, further including simulating what-if scenarios based on the one or more mitigation actions.
